(19) United States
(12) Patent Application Publication
(10) Pub. No.: US 2006/0112238 A1
(43) Pub. Date: May 25, 2006

(54) Techniques for pushing data to a processor cache

(76) Inventors: Sujat Jamil, Austin, TX (US); Samantha J. Edirisooriya, Tempe, AZ (US); Hang T. Nguyen, Tempe, AZ (US); David E. Miner, Chandler, AZ (US); R. Frank O'Bleness, Tempe, AZ (US); Steven J. Tu, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/997,605

(22) Filed: Nov. 23, 2004

(51) Int. Cl. G06F 12/00

(52) U.S. Cl. 711/145

(57) ABSTRACT

A technique to write data to a processor cache without using intermediate memory storage. More particularly, embodiments of the invention relate to various techniques for writing data from a bus agent to a processor cache without having to first write the data to memory and then having the processor read the data from the memory.

### FIELD

Embodiments of the invention relate to the field of microprocessor architecture. More particularly, embodiments of the invention relate to various techniques for writing data from a bus agent to a processor cache without having to first write the data to memory and then having the processor read the data from the memory.

### BACKGROUND

Typically, bus agents residing in a computer system have had to first write (“push”) data to a location in a memory device, such as dynamic random access memory (DRAM), such as main memory, or static RAM (SRAM) location, such as a level-2 (L2) cache, external to the processor or processors for which the data is intended. The target processor or processors would then have to read the data from the memory location, incurring read cycles that can hamper processor and system performance.

FIG. 1 illustrates a computer system in which an external bus agent (“pushing agent”) writes data first to memory that is later retrieved by the target processors. The data pushing technique illustrated in FIG. 1 requires access cycle time for the write from the pushing agent to the memory and access cycle time for the processor to retrieve the data from the memory.

The target processor(s) typically store the retrieved data into an internal cache within the processor, such as a level-1 (L1) cache. Prior art techniques have, therefore, been developed to write the target data from the external agent to the processor's internal cache directly (i.e. without first writing the data to memory and later retrieved by the target processor). In multi-processor systems, it may be necessary for cache coherency to be maintained among the processors in the system.

Prior art techniques have been developed to address the coherency problem for multi-processor systems by for, example, specifying a fixed target processor address encoded by the pushing agent driven onto the interconnect between the external agent and the target processor(s), dynamically selection of the target processor(s) by the external agent, and simply treating all processors in the system as targets such that the data is always written to each processor's internal cache. However, prior art techniques require the external agent, or “pushing” agent, to be aware of, such things as how many processors are in the system at any given time, how to address each processor, etc.

FIG. 2 illustrates a prior art technique for writing data directly to the target processor(s), wherein the pushing agent is responsible for which processor(s) will receive push data without any input from the target processor(s), and wherein the pushing agent is responsible for maintaining coherency among the processors' internal caches. In the example illustrated, in FIG. 2, the pushing agent encodes a target in the push request driven onto the interconnect between the agent and the processor(s).

In applications, such as those using symmetric processing, in which push data may not be associated with a specific processor, or dynamically configurable systems, in which the processor resources may change in number and/or address, or other applications in which sufficient information about the processors in the system may not be available and/or it is not desirable to write data to all processors in the system, the prior art methods for directly writing data to a processor or processors while maintaining cache coherency between the processors may not provide the best solution. In general, prior art techniques for writing data directly from a bus agent to a processor's internal cache while maintaining cache coherency with other processors or agents within the system has been largely push agent-focused, in that it is the responsibility of the writing bus agent to maintain coherency among the target processors or agents.

Requiring the push agent to maintain coherency can be limiting in the number of applications available to direct data pushing techniques, such as those previously discussed.

### BRIEF DESCRIPTION OF THE DRAWINGS

Embodiments and the invention are illustrated by way of example and not limitation in the figures of the accompanying drawings, in which like references indicate similar elements and in which:

FIG. 1 illustrates a computer system in which push data is written first to a memory location and later retrieved by the target processor(s).

FIG. 2 illustrates a computer system in which push data is written to a target processor based on an arbitration scheme implemented by the pushing agent.

FIG. 3 illustrates a shared bus computer system in which at least one embodiment of the invention may be used.

FIG. 4 illustrates a point-to-point (PtP) computer system in which at least one embodiment of the invention may be used.

FIG. 5 illustrates a technique, according to one embodiment of the invention, in which the push target is arbitrated by the processors within the computer system by responding to push request driven to a number of processors within the system by the pushing agent.

FIG. 6 illustrates operations that may be used in one embodiment of the invention in conjunction with the technique illustrated in FIG. 5.

FIG. 7 illustrates a technique, according to one embodiment of the invention, in which a pushing agent writes data directly to at least one processor's internal cache by using a “push and lock” command.

FIG. 8 illustrates operations that may be used in one embodiment of the invention in conjunction with the technique illustrated in FIG. 7.

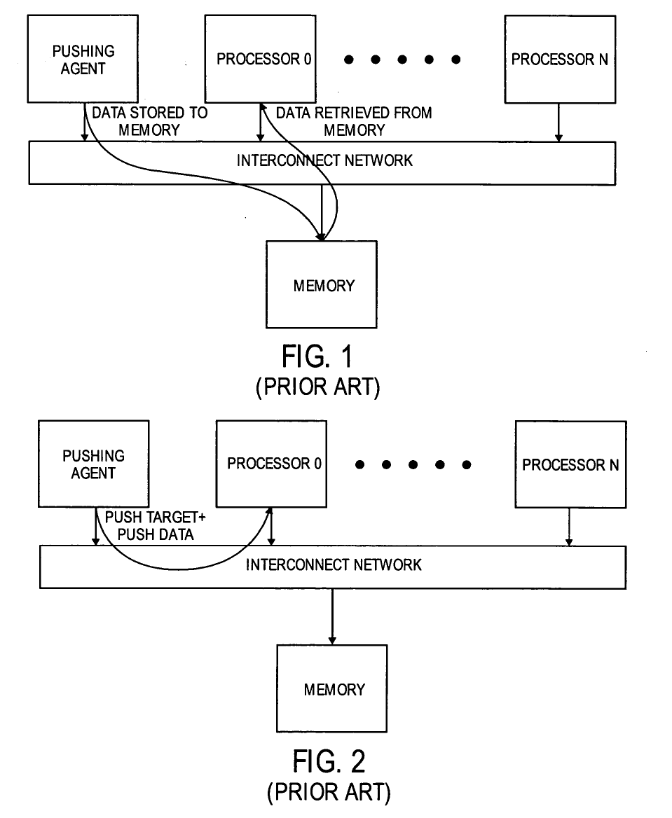

### DETAILED DESCRIPTION

Embodiments of the invention described herein relate to multi-processor systems. More particularly, embodiments of the invention described herein relate to techniques to write data from a bus agent within a multi-processor computer system to one or more processors within the system without having to first write the data to a memory location external to the target processor(s) from which the data may be retrieved by the target processor(s). Furthermore, embodiments of the invention described herein relate to techniques for pushing data from a bus agent to at least one processor within a multi-processor system, in which the processor(s) are at least partially responsible for arbitrating the target of the push data and for maintaining cache coherency between the various processors within the system.

As multi-processor system become more complex and diverse, the need for decentralizing the arbitration of push data and cache coherency becomes important in direct-push system architectures. Fortunately, embodiments described herein may be used in any number of multi-processor system configurations, including those of the prior art, while allowing for greater flexibility in designs of these systems. Two general computer system architectures are described in this disclosure by way of example—a shared bus architecture (or “front-side bus” architecture) and a point-to-point (PtP) system architecture. However, embodiments of the invention are not limited to these computer systems, and may be readily used in any number of multi-processor computer systems in which data is pushed directly to the processor(s) within the system rather than first being stored to a memory external to the processors from which the processor(s) may retrieve the data.

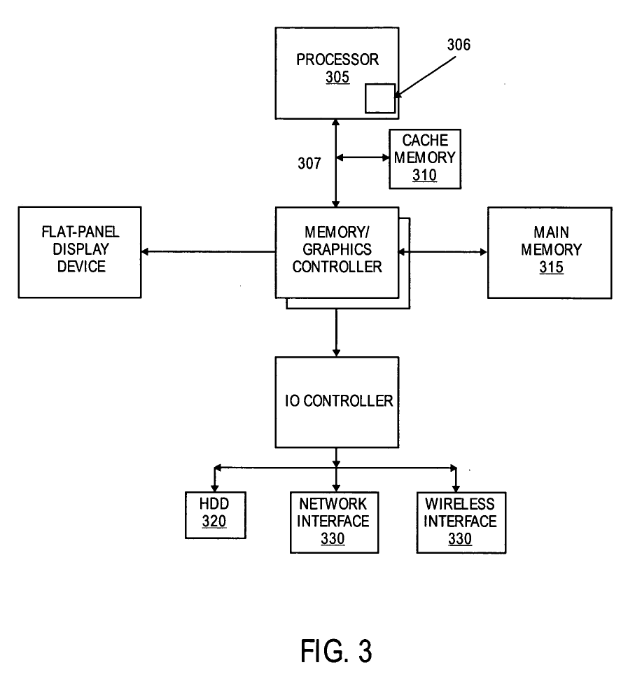

FIG. 3 illustrates a shared bus system, or “front-side-bus” (FSB) computer system, in which one embodiment of the invention may be used. A processor 305 accesses data from a level one (L1) cache memory 310 and main memory 315. In other embodiments of the invention, the cache memory may be a level two (L2) cache or other memory within a computer system memory hierarchy. Furthermore, in some embodiments, the computer system of FIG. 3 may contain both a L1 cache and an L2 cache, which comprise an inclusive cache hierarchy in which coherency data is shared between the L1 and L2 caches.

Illustrated within the processor of FIG. 3 is one embodiment of the invention 306. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 320, or a memory source located remotely from the computer system via network interface 330 containing various storage devices and technologies. The cache memory may be located either within the processor or in close proximity to the processor, such as on the processor's local bus 307. Furthermore, the cache memory may contain relatively fast memory cells, such as a six-transistor (6T) cell, or other memory cell of approximately equal or faster access speed.

The computer system of FIG. 3 may be a point-to-point (PtP) network of bus agents, such as microprocessors, that communicate via bus signals dedicated to each agent on the PtP network. Within, or at least associated with, each bus agent is at least one embodiment of invention 306, such that store operations can be facilitated in an expeditious manner between the bus agents.

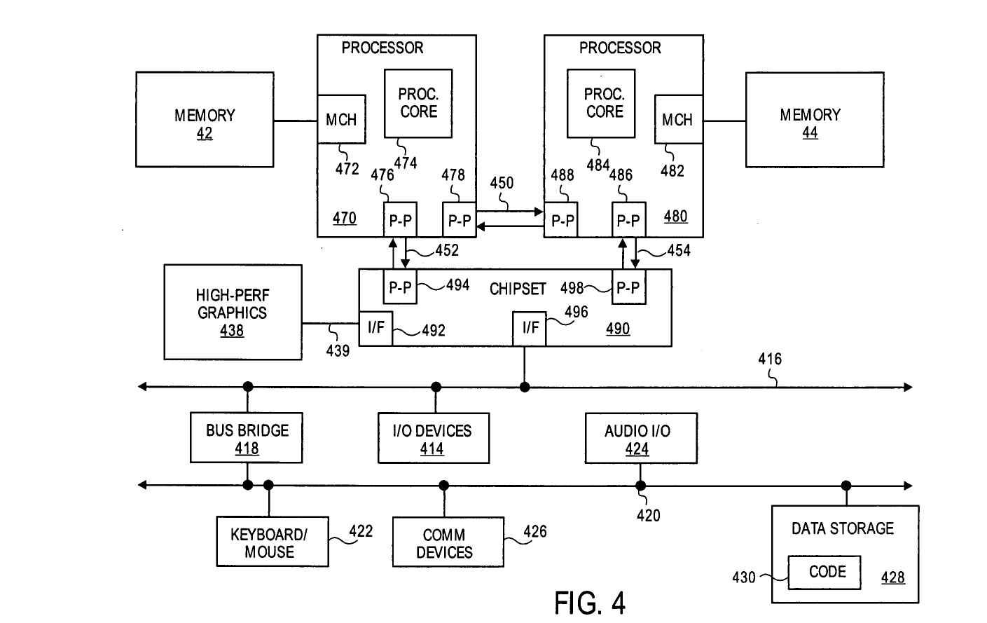

FIG. 4 illustrates a computer system that is arranged in a point-to-point (PtP) configuration. In particular, FIG. 4 shows a system where processors, memory, and input/output devices are interconnected by a number of point-to-point interfaces.

The system of FIG. 4 may also include several processors, of which only two, processors 470, 480 are shown for clarity. Processors 470, 480 may each include a local memory controller hub (MCH) 472, 482 to connect with memory 22, 24. Processors 470, 480 may exchange data via a point-to-point (PtP) interface 450 using PtP interface circuits 478, 488. Processors 470, 480 may each exchange data with a chipset 490 via individual PtP interfaces 452, 454 using point to point interface circuits 476, 494, 486, 498. Chipset 490 may also exchange data with a high-performance graphics circuit 438 via a high-performance graphics interface 439.

At least one embodiment of the invention may be located within the PtP interface circuits within each of the PtP bus agents of FIG. 4. Other embodiments of the invention, however, may exist in other circuits, logic units, or devices within the system of FIG. 4. Furthermore, other embodiments of the invention may be distributed throughout several circuits, logic units, or devices illustrated in FIG. 4.

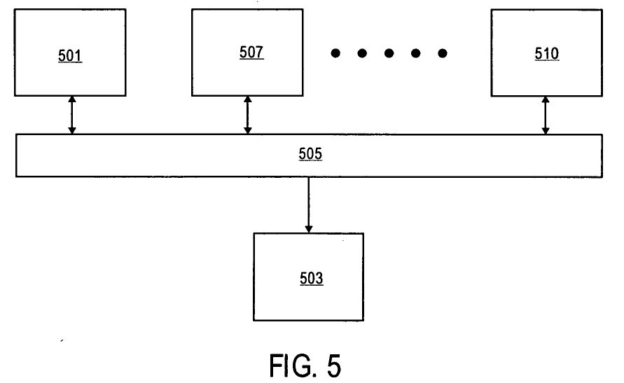

FIG. 5 illustrates a technique, according to one embodiment of the invention, in which a bus agent (“push agent”) signals an intention to push the data, followed by responses from potential target processors requesting to receive the push data. Specifically, pushing agent 501 issues a push request signal onto the interconnect network 505 connecting the push agent to the various processors within the system. In one embodiment, which the pushing agent and processors are part of a shared bus system, the push request may be detected by the processors by snooping a shared address bus transaction. In PtP computer system, the push request may be sent to all processors in the system and the memory 503 as well.

Processors 507 and 510 respond with a signal indicating that they are candidates to receive the push data from the pushing agent. In other embodiments one, none, or more processors may respond. In shared bus systems, a processor may respond to the push request by driving a “push target candidate” (PTC) signal on the bus during a shared bus signaling phase, such as a response phase. In a PtP computer system, a processor may respond to the push request by issuing a PTC message from the processor to the pushing agent or push arbiter.

The decision for whether a processor responds may be based off a number of criteria. For example, the processor(s) may respond based on whether it has the push data already cached, whether the processor(s) has/have enough resources, such as buffer and/or queue space, available to process the push request, whether the push request matches against a push address range designated within the processor, or whether there are competing accesses for shared cache, buffer, or queue resources. In other embodiments other criteria may determine whether a processor responds as a candidate to receive the push data, including whether accepting the data will cause data within a processor's cache to be replaced.

Once each processor has indicated that it is a candidate to receive the push data, the choice of which processor(s) to which the data is to be sent is arbitrated. In one embodiment, the push arbitration is done by the push agent itself. In other embodiments, the push arbitration is done by a separate push arbiter or within one or more of the processors. Yet, in other embodiments, the arbitration may be distributed throughout the pushing agent, the processors, and/or a push arbiter. Any arbitration scheme may be used in determining the appropriate recipient processor(s) for the push data. For example, in one embodiment, the arbitration scheme is “round-robin” scheme, in which each processor in the system receives data in a particular order. Furthermore, a static priority arbitration scheme may be used, in which a priority among the processors is maintained for each push. Still, in other embodiments, other arbitration schemes may be used.

In the event that no processors respond as candidates to receive the push data, various embodiments of the invention may use varying techniques to deal with this situation. For example, in one embodiment of the invention, at least one processor is guaranteed to respond as a candidate to receive the data. In another embodiment, the pushing agent or push arbiter chooses one of the processors to accept the data. In another embodiment, the default recipient is always the memory controller, which can then write the push data to memory external to the processor(s), such as DRAM. However, in other embodiments, the push may simply be aborted. Other arbitration schemes may be used in other embodiments in the event that no processor responds as a candidate to receive the push data.

In one embodiment of the invention, the processor(s) to receive the push data is notified by a signal from the pushing agent. In a shared bus system, the notification may be done by driving a “selected push target” (SPT) signal during a bus signaling phase, such as during a response phase. In a PtP system, the SPT message may be sent by the pushing agent or some other arbiter agent to the receiving processor(s). In other embodiments, no such notification is given to the receiving processor(s) and the data is simply delivered.

After the determination of the recipient processor(s) is made, the push data may be delivered to the recipient processor(s) and the non-recipient processor(s) may invalidate any prior copies of the data they may have in their internal caches. The recipient processor(s) receives the data from the pushing agent and stores it in its cache, overwriting any existing copy of the data.

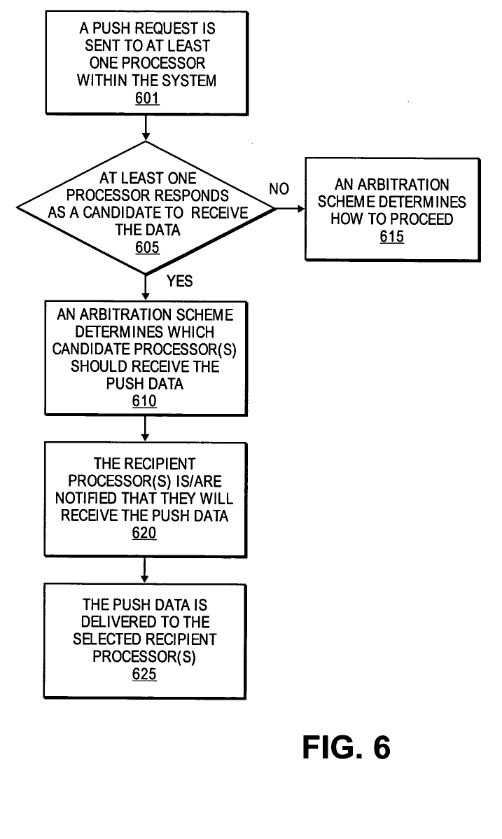

FIG. 6 is a flow diagram illustrating one embodiment of the invention in which techniques described in reference to FIG. 5 are used to deliver push data to at least one processor within a computer system. At operation 601, a push request is send to at least one processor within the system. At operation 605, if at least one processor responds as a candidate to receive the data, then an arbitration scheme determines which candidate processor(s) should receive the push data at operation 610. At operation 615, if no operations respond, then an arbitration scheme determines how to proceed. In one embodiment, if no processor's respond to the push request, then the data is written to the memory controller, which can write the push data to memory external to the processors, such as DRAM. If a recipient processor is selected, then at operation 620, the recipient processor(s) is/are notified that they will receive the push data. In other embodiments, no notification may be given. Finally, at operation 625, the push data is delivered to the selected recipient processor(s).

In some applications in which embodiments of the invention may be used, the recipient processor(s) may require that the push data not be modified by subsequent cache write operations. Cached data within a processor may be replaced according to such algorithms, as a “least-recently used” (LRU) algorithm, not-recently used (NRU) algorithm, or round-robin algorithm, etc. Accordingly, at least one embodiment of the invention supports a command or other signal that may be issued along with the push data to prevent subsequent writes to the location the push memory is written (or “lock” the memory location). Other processors that did not receive the data from the push agetn may arbitrate with the processor(s) that did receive the data in order to access the data.

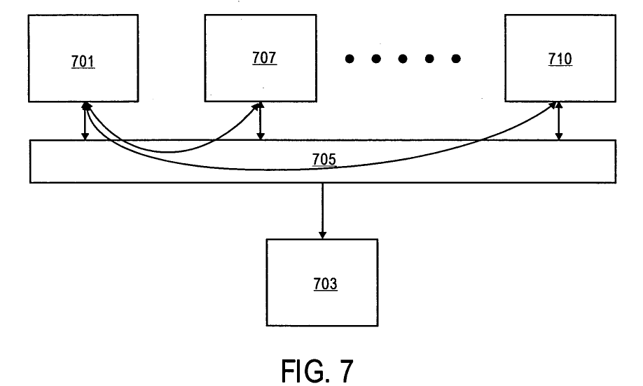

FIG. 7 illustrates an embodiment of the invention in which a bus agent issues a “lock and push” command in conjunction with the push data to indicate to the target processor(s) that the push data is to be locked within the target processor's/processors' cache. Specifically, FIG. 7 illustrates processors 707 and 710, which have an associated cache memory within each of the processors, receiving a “push and lock” command 702 from another bus agent 701, such as an Ethernet media access controller (MAC), across an interconnect 705. If no processor accepts the “push and lock” command, in the system of FIG. 7, the data may be pushed and locked into another memory device 703, such as DRAM, by the memory controller.

In other embodiments, the system of FIG. 7 may include more processors to receive the “push and lock” command. Furthermore, in other embodiments, the interconnect may be a shared bus or PtP bus. Depending on the system, the command may be different than the one illustrated in FIG. 7, composed of multiple commands, or be a signal or group of signals within the interconnect. Moreover, in other embodiments the data may be written to other bus agents or processors if no processor accepts the data, or the push may simply be aborted. Other processors that did not receive the data from the push agetn may arbitrate with the processor(s) that did receive the data in order to access the data.

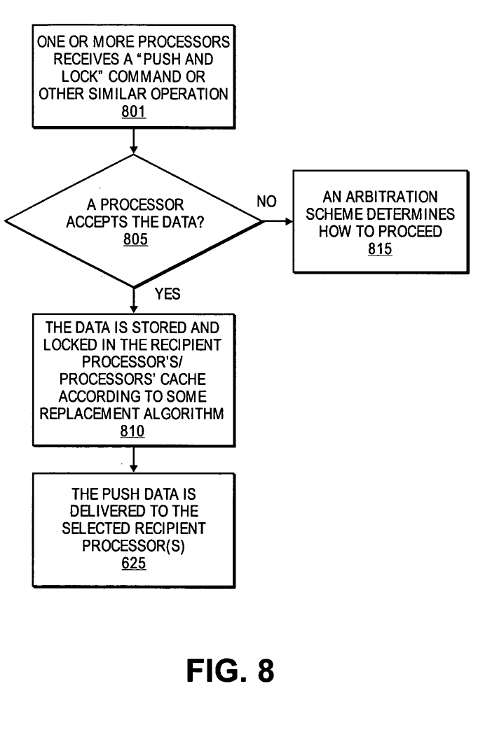

FIG. 8 is a flow diagram illustrating one embodiment that may be implemented within the system illustrated in FIG. 7. At operation 801, one or more processors receives a “push and lock” command or other similar operation. If a processor accepts the data, at operation 805, then the data is stored and locked in the recipient processor's/processors' cache according to some replacement algorithm 810. However, if no processor accepts the data, because, for example, there are no cache ways available to store and lock the data, then some algorithm may be used to decide where the data should be stored at operation 815. In one embodiment, one or more processor's cache is unlocked and the data replaced with the push data according to a replacement algorithm. In another embodiment, the push data is stored to a memory location external to the processors, such as DRAM, by a memory controller if none of the processors accept the push data. Other embodiments may use other algorithms to decide what happens to the push data in the event that no processors can accept the data.

Embodiments of the invention may be implemented using complementary metal-oxide-semiconductor (CMOS) logic circuits (“hardware”), whereas other embodiments may be implemented using a set of instructions (“software”) stored on a machine-readable medium, which when executed by a machine, cause the machine to perform operations commensurate with the various embodiments described herein. Other embodiments may be implemented using some combination of hardware and software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. An apparatus comprising:
first means to send data to be written to a first processor's cache memory without the data being first written to another memory and later stored to the first processor's cache memory;
second means to indicate whether the first processor is able to receive the data within its cache;
third means to determine where the data is to be stored if the second means indicates that the first processor is not able to receive the data.

2. The apparatus of claim 1 further comprising a fourth means to maintain coherency between the first processor's cache and other processors' caches coupled to the first processor.

3. The apparatus of claim 2 wherein the first means includes a push signal generated within a bus agent external to the first and other processors, the push signal to indicate that bus agent has data to write to a cache of least one of the first and other processors.

4. The apparatus of claim 3 wherein the second means includes a candidate signal generated by at least one of the first and other processors, the candidate to indicate that the at least one of the first and other processors can receive the data into its respective cache.

5. The apparatus of claim 4 wherein the third means is to store the data within a memory external to the first and other processors if the second means indicates that none of the first and other processors can receive the data.

6. The apparatus of claim 2 wherein the fourth means causes other processors to invalidate copies of the data stored in their respective caches it the first processor is to receive the data within its cache.

7. The apparatus of claim 1 wherein the first, second, and third means are included within a shared bus computer system.

8. The apparatus of claim 1 wherein the first, second, and third means are included within a point-to-point computer system.

9. A system comprising:
a bus agent to store push data to at least one processor within a computer system to which the bus agent corresponds;
a plurality of processors coupled to the bus agent to indicate whether they may receive the push data;
an arbiter to determine which of the plurality of processors, if any, are to receive the push data and to determine what to do with the push data if none of the plurality of processors are to receive the push data.

10. The system of claim 9 further comprising an interconnect coupling the arbiter, plurality of processors, and bus agent together.

11. The system of claim 10 wherein the bus agent is to issue a push request signal across the interconnect to the plurality of processors to indicate that the bus agent is to store push data to at least one processor.

12. The system of claim 11 wherein at least one of the plurality of processors is to issue a push target candidate signal across the interconnect to the bus agent in response to the push request signal to indicate that the at least one of the plurality of processors is able to store the push data within its cache.

13. The system of claim 12 wherein the bus agent is to issue a selected push target signal across the interconnect to the at least one of the plurality of processors in response to the push target candidate signal to indicate that the at least one of the plurality of processors is to receive the push data.

14. The system of claim 13 wherein the bus agent is issue the push data across the interconnect to the at least one of the plurality of processors after the bus agent has issued the selected push target signal.

15. The system of claim 9 wherein the arbiter is to select a processor among the plurality of processors according to any of a plurality of arbitration schemes consisting of: a round-robin arbitration, a static-priority arbitration, and a dynamic-priority arbitration.

16. The system of claim 9 wherein the arbiter is to select one of the plurality of processors to receive the push data if none of the plurality of processors indicates that they may receive the push data.

17. The system of claim 10 wherein the arbiter is to send the push data to a memory controller across the interconnect if none of the plurality of processors is able to receive the push data.

18. A method comprising:
indicating a store operation to a plurality of processors, the store operation to store data to a cache within at least one of the plurality of processors without the data being stored first within a memory external to the plurality of processors from which the at least one processor may retrieve the data;
indicating whether at least one of the plurality of processors may receive the data;
storing the data to a cache within at least one of the plurality of processors if at least one of the plurality of processors indicates that it can receive the data;
storing the data to a memory location external to the plurality of processors if none of the plurality of processors indicates that they may receive the data.

19. The method of claim 18 wherein the data is stored within either at least one of a plurality of processors or the memory location and locked so as to prevent subsequent store operations from overwriting the data.

20. The method of claim 19 wherein the indication of the store operation comprises issuing a push request operation from a bus agent external to the plurality of processors.

21. The method of claim 20 wherein the indication of whether at least one processor can receive the data comprises issuing a push target candidate operation to the bus agent.

22. The method of claim 21 wherein the plurality of processors and the bus agent are coupled by a shared bus.

23. The method of claim 21 wherein the plurality of processors and the bus agent are coupled by a point-to-point bus.

24. A machine-readable medium having stored thereon a set of instructions, which if executed by a machine, cause the machine to perform a method comprising:
issuing a push request from a bus agent to a plurality of processors;
receiving a push data accept signal from at least one of the plurality of processors;
determining which of the plurality of processors is to receive push data;
storing the push data to at least one of the at least on of the plurality of processors from which a push data accept signal is received.

25. The machine-readable medium of claim 24 wherein the method further includes determining where to store the push data if none of the plurality of processors indicates that they can receive the push data.

26. The machine-readable medium of claim 25 wherein the push data is stored to a memory device external to the plurality of processors if none of the plurality of processors indicates that they can receive the push data.

27. The machine-readable medium of claim 25 wherein the push data is stored to one of the plurality of processors if none of the plurality of processors indicates that they can receive the push data.

28. The machine-readable medium of claim 25 wherein the storing is canceled if none of the plurality of processors indicates that they can receive the push data.

29. The machine-readable medium of claim 25 wherein the instructions are to be executed within a shared bus computer system.

30. The machine-readable medium of claim 25 wherein the instructions are to be executed within a point-to-point bus computer system.
